(19) United States
(12) Patent Application Publication
(10) Pub. No.: US 2024/0323794 A1
(43) Pub. Date: Sep. 26, 2024

(54) RETURN TO CELLULAR COVERAGE

(71) Applicant: QUALCOMM Incorporated, San Diego, CA (US)

(72) Inventors: Roop Sagar INAKOLLU, San Diego, CA (US); Syam Pavan VADAPALLI, Visakhapatnam (IN); Ankammarao RAVUVARI, Hyderabad (IN); Sai Lokesh LADHAGIRI KRISHNAKUMAR, Hyderabad (IN)

(21) Appl. No.: 18/188,387

(22) Filed: Mar. 22, 2023

(51) Int. Cl. H04W 36/32

(52) U.S. Cl. CPC H04W 36/32; H04B 7/18513

(57) ABSTRACT

Aspects presented herein may enable a UE to guide its user to return to an area with cellular coverage when the UE is about to become out-of-service (OOS) and/or after the UE becomes OOS. In one aspect, a UE detects that the UE is within a threshold distance of an edge cell of a set of cells for a network. The UE records a set of locations of the UE with a cellular coverage based on detecting that the UE is within the threshold distance of the edge cell. The UE detects that the UE is OOS or soon to be OOS of the network. The UE indicates at least one location in the set of locations of the UE in response to a detection that the UE is OOS.

### TECHNICAL FIELD

The present disclosure relates generally to communication systems, and more particularly, to a wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus detects that the user equipment (UE) is within a threshold distance of an edge cell of a set of cells for a network. The apparatus records a set of locations of the UE with a cellular coverage based on detecting that the UE is within the threshold distance of the edge cell. The apparatus detects that the UE is out-of-service (QOS) or soon to be OOS of the network. The apparatus indicates at least one location in the set of locations of the UE in response to a detection that the UE is OOS.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a non-terrestrial network (NTN) architecture based on a transparent payload in accordance with various aspects of the present disclosure.

FIG. 6 is a diagram illustrating an example of an NTN architecture based on a regenerative payload in accordance with various aspects of the present disclosure.

FIG. 7A is a diagram illustration an example network that includes both NTN and terrestrial network (TN) devices in accordance with various aspects of the present disclosure.

FIG. 7B is a diagram illustration an example network that includes both NTN and TN devices in accordance with various aspects of the present disclosure.

FIG. 8 is a diagram illustrating an example of a UE goes into out-of-service (OOS) due to lack of cellular coverage in accordance with various aspects of present disclosure.

FIG. 9 is a diagram illustrating an example edge cell/sector in accordance with various aspects of the present disclosure.

FIG. 10 is a diagram illustrating an example of a UE maintaining a database that includes a set of locations with cellular coverages in accordance with various aspects of the present disclosure.

FIG. 11 is a diagram illustrating an example of a UE indicating a last known location with cellular coverage to a user in accordance with various aspects of the present disclosure.

FIG. 12 is a block diagram illustrating an example of enabling a UE to guide its user to return to cellular coverage in accordance with various aspects of the present disclosure.

FIG. 13 is a diagram illustrating an example of enabling a UE to fetch/download NTN information from a server in accordance with various aspects of the present disclosure.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

### DETAILED DESCRIPTION

Aspects presented herein may enable a user equipment (UE) to guide its user to return to an area with cellular coverage when the UE is about to become out-of-service (OOS) (e.g., disconnect from a network) and/or after the UE becomes OOS. For example, aspects presented herein may enable a UE to record a set of locations with good cellular coverages (e.g., with communication link/channel quality above a quality threshold). Then, if the UE becomes OOS, the UE may indicate to its user about at least one last known location (or a closest known location) with the good cellular coverage (e.g., selected from the recorded set of locations), such that the user may have access to the network again by taking the UE to the indicated last known location. As such, aspects presented herein provide a cost-effective way to enhance the safety of users that are out of cellular coverage of available networks.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

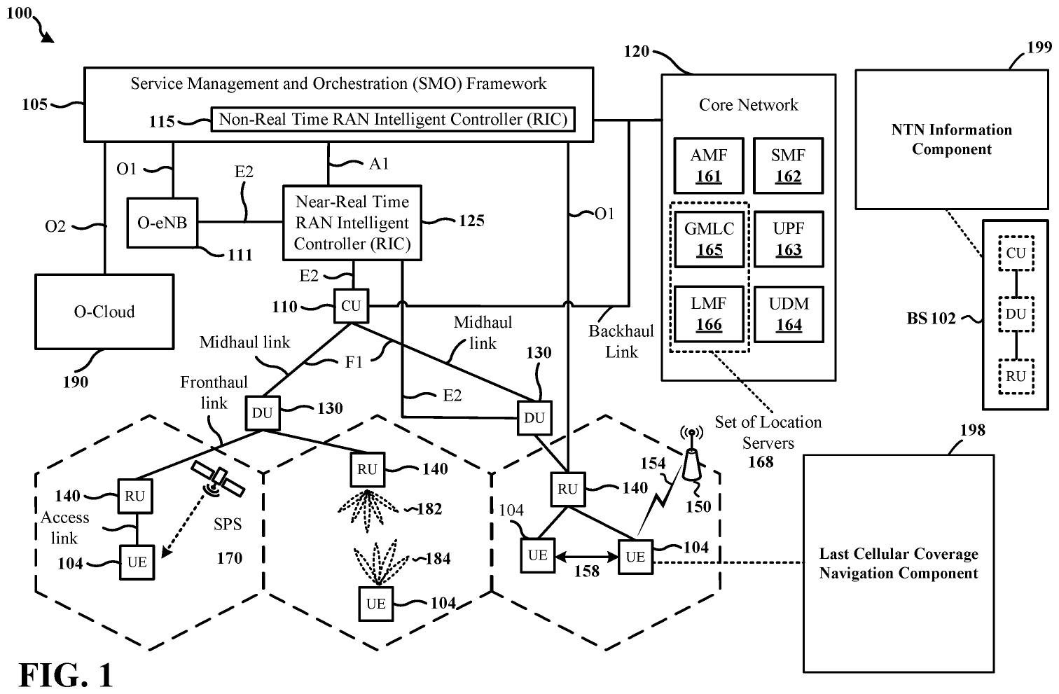

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUS 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a last cellular coverage navigation component 198 that may be configured to detect that the UE is within a threshold distance of an edge cell of a set of cells for a network; record a set of locations of the UE with a cellular coverage based on detecting that the UE is within the threshold distance of the edge cell; detect that the UE is OOS or soon to be OOS of the network; and indicate at least one location in the set of locations of the UE in response to a detection that the UE is OOS. In certain aspects, the base station 102 may have an NTN information component 199 that may be configured to provide NTN information to a UE, such as via broadcasting SIB19 and/or transmitting NTN information collected from other UEs (e.g., based on crowdsourcing).

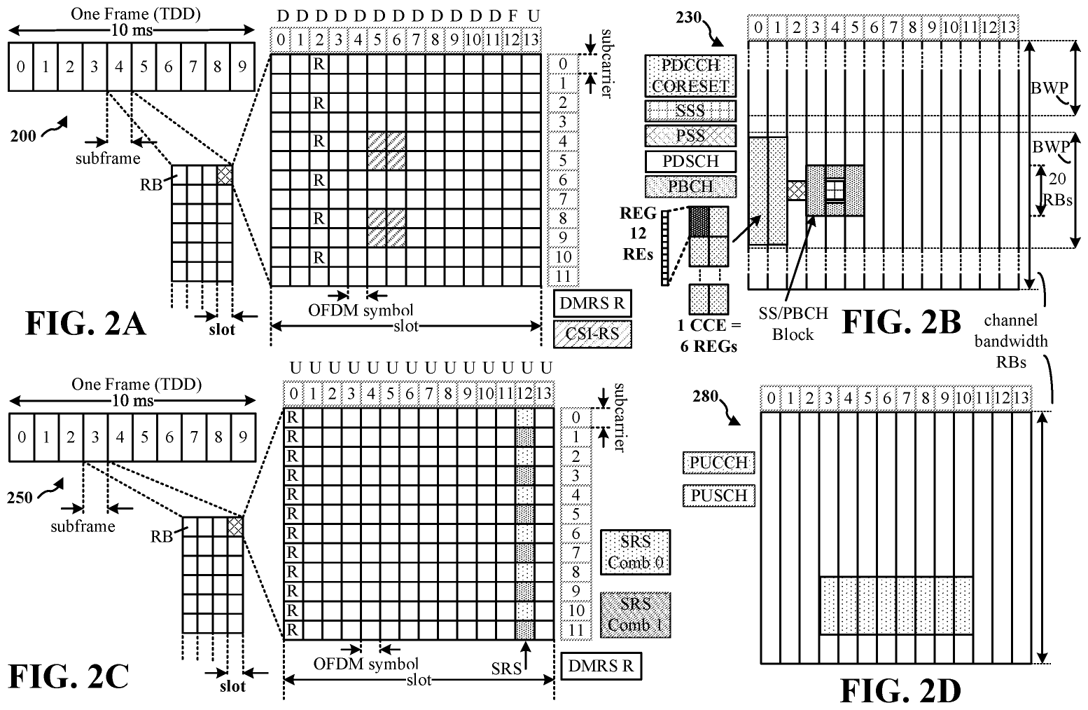

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A. 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

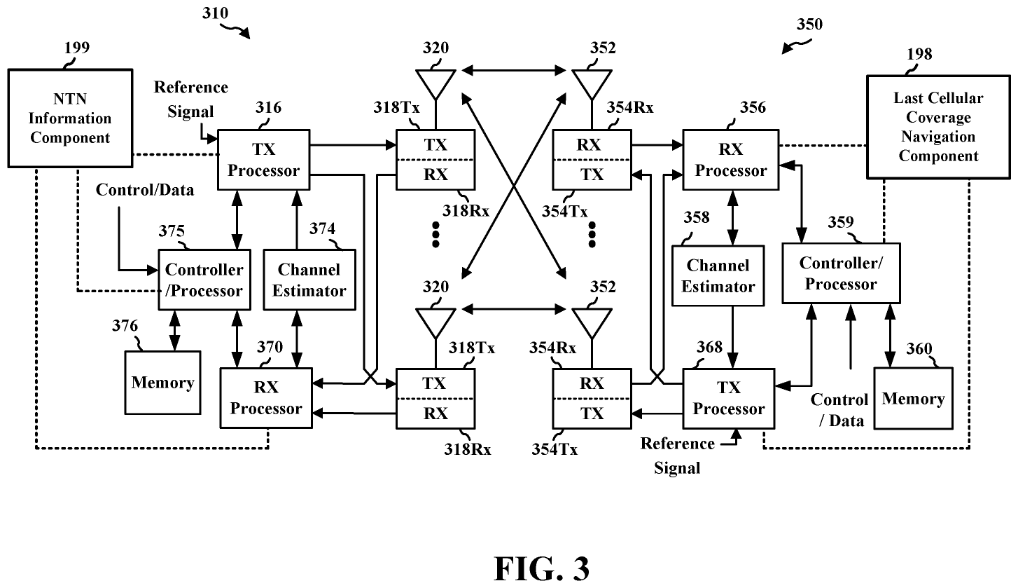

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions, Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency-domain, and then combined together using an Inverse Fast Fourier Transform (IFFT) to produce a physical channel carrying a time-domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency-domain using a Fast Fourier Transform (FFT). The frequency-domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the last cellular coverage navigation component 198 of FIG. 1.

At least one of the TX processor 316, the RX processor 370, and the controller/processor 375 may be configured to perform aspects in connection with the NTN information component 199 of FIG. 1.

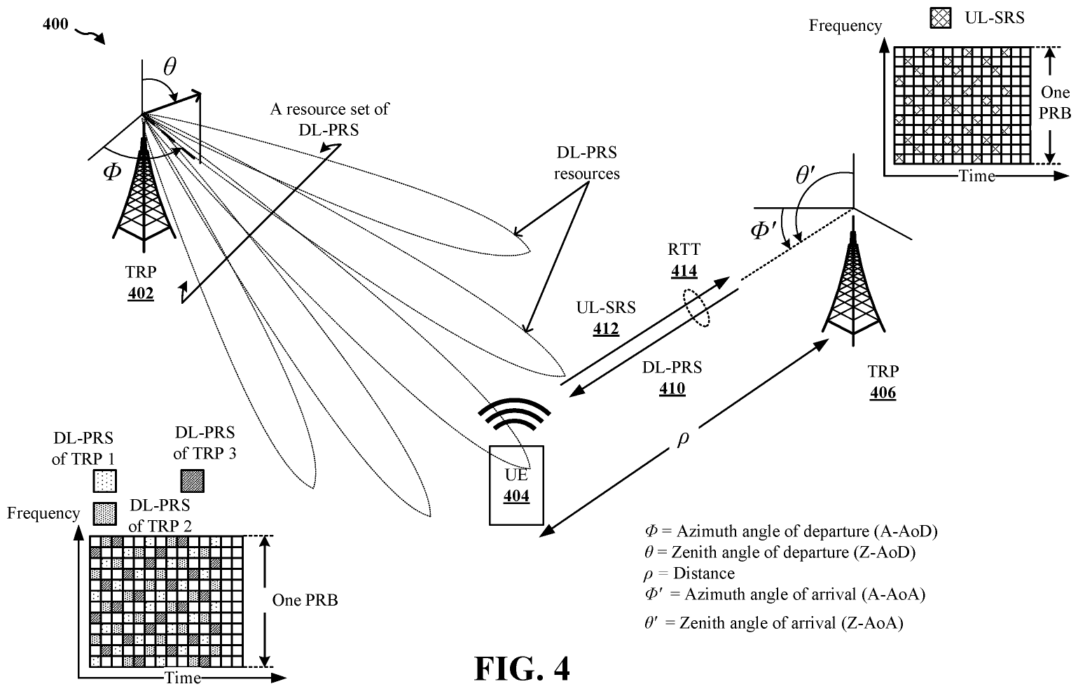

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ||T_{SRS_RX}−T_{PRS_TX}|−|T_{SRS_TX}−T_{PRS_RX}||. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402,406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS. SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

A UE may communicate with a network entity that is non-terrestrial, which may be referred to as a non-terrestrial network (NTN). An NTN may refer to a network, or segments of a network, using at least one airborne device (e.g., an aircraft) or satellite (e.g., a low earth orbit (LEO) satellite, a medium earth orbit (MEO) satellite, a geostationary earth orbit (GEO) satellite, a high elliptical orbit (HEO) satellite, and/or a high-altitude pseudo satellite (HAPS), etc.) for communication (e.g., for transmitting data or receiving data). For example, an NTN may support a direct communication between a UE (e.g., a handset, a mobile phone, etc.) and a satellite (e.g., a LEO satellite, a GEO satellite, etc.), where the UE may transmit data (e.g., text messages and/or voice services, etc.) to another UE via the satellite. For purposes of the present disclosure, an NTN may include just NTN cell(s), or a mix of NTN cell(s) and ground cell(s). As such, for a positioning operation associated with an NTN, the positioning operation may involve NTN cell(s) without ground cell(s), a mix of NTN and ground cells, and/or hybrid solutions involving NTN cells, ground cells, GNSS satellites, and/or other ground-based positioning reference points such as WiFi, Bluetooth, etc.

In some aspects, determining/knowing a position of a UE may be an important factor for an NTN. For example, location information of a UE may be used in a radio-access network (RAN) for an initial synchronization, uplink timing and frequency pre-compensation, mobility, and/or handover, etc. In addition, an NTN may support different types of UEs, such as UEs with global navigation satellite system (GNSS) support (e.g., the positions of the UEs may be determined via global positioning system (GPS)) and/or UEs without GNSS support. In some examples, it may be advantageous for a UE to perform a positioning session with an NTN as the NTN may enable the UE to interact with the satellite(s). For example, the PRS signals transmitted from a satellite may be tailored to or configured for a specific UE. As such, the performance, and/or the accuracy of a positioning of a UE based on GNSS may further be supplemented with the assistance of an NTN as the UE and/or the satellite may exchange positioning related information with each other.

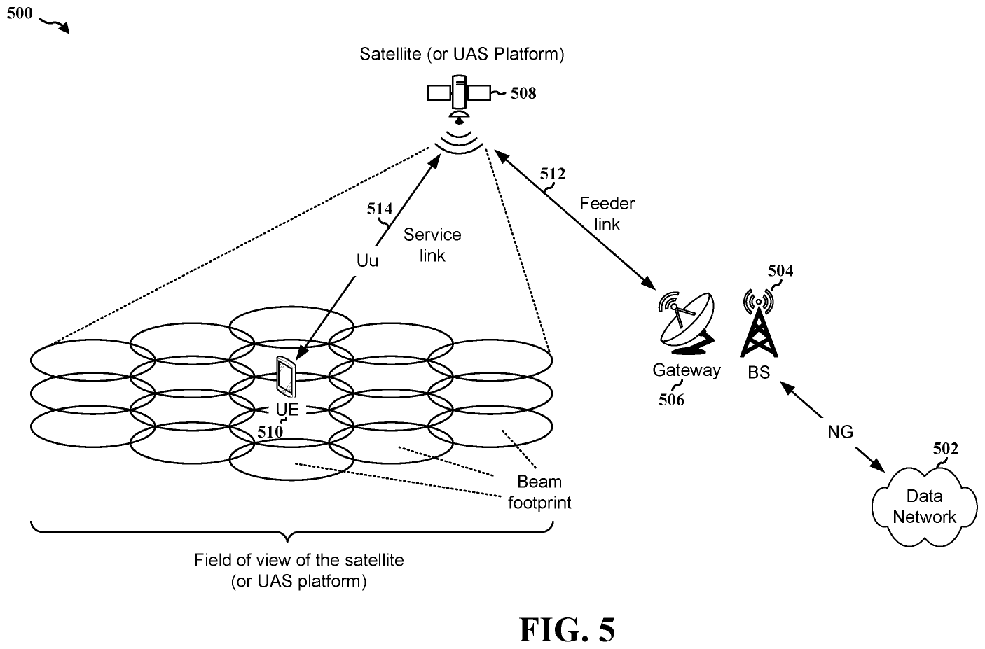

FIG. 5 is a diagram 500 illustrating an example of an NTN architecture based on a transparent payload in accordance with various aspects of the present disclosure. A data network 502 (e.g., a 5G core (5GC) network) may connect to a base station 504 (e.g., a network entity, an gNB) via a communication interface (e.g., a next generation (NG) interface). The base station 504 may be located on the ground and connected to an NTN gateway 506, where the NTN gateway 506 may be connected to an NTN payload 508 (e.g., a network node embarked onboard a satellite, an unmanned aircraft systems (UAS), or HAPS, etc.) via a feeder link 512. The NTN payload 508 may connect to a UE 510 via a service link 514 (e.g., using the UE-Satellite (Uu) interface). Under the transparent payload NTN architecture, the base station 504 may be a ground station and the NTN payload 508 (e.g., the satellite) may function like a relay, where the NTN payload 508 may provide radio frequency filtering, frequency conversion, and/or amplification for data/payload received from the base station 504 via the NTN gateway 506 and relay/transmit the data/payload to the UE 510. As such, the waveform or signal relayed/repeated by the NTN payload 508 may be un-changed. In some examples, the ground area(s) covered by the NTN payload 508 may be referred to as “footprint(s)” and/or “beam footprint(s).” The footprint of a satellite may be a ground area in which its transponders offer coverage, and the footprint may also determine the satellite dish diameter for receiving each transponder's signal. In some examples, there may be a different coverage map for each transponder (or group of transponders), as each transponder may be configured to cover different areas. Table 2 below shows examples of altitudes and footprint sizes for different types of satellite platforms, where different satellite platforms may have different distance, delay, and/or coverage on the earth.

TABLE 2
example altitudes and footprint sizes for
different types of satellite platforms

| | | | | Typical Beam | |
|---|---|---|---|---|---|
| Platforms | Altitude Range | | Orbit | Footprint Size | |
| Low-Earth Orbit | 300-1500 | km | Circular around | 100-1000 | km |
| (LEO) satellite | | | the earth | | |
| Medium-Earth | 7000-25000 | km | | 100-1000 | km |
| Orbit (MEO) | | | | | |
| satellite | | | | | |
| Geostationary | 35786 | km | Notional station | 200-3500 | km |
| Earth Orbit | | | keeping position | | |
| (LEO) | | | fixed in terms of | | |
| satellite | | | elevation/azimuth | | |
| UAS platform | 8-50 km (20 km | | with respect to a | 5-200 | km |
| (including HAPS) | for HAPS) | | given earth point | | |
| High Elliptical | 400-50000 | km | Elliptical around | 200-3500 | km |
| Orbit (HEO) | | | the earth | | |
| satellite | | | | | |

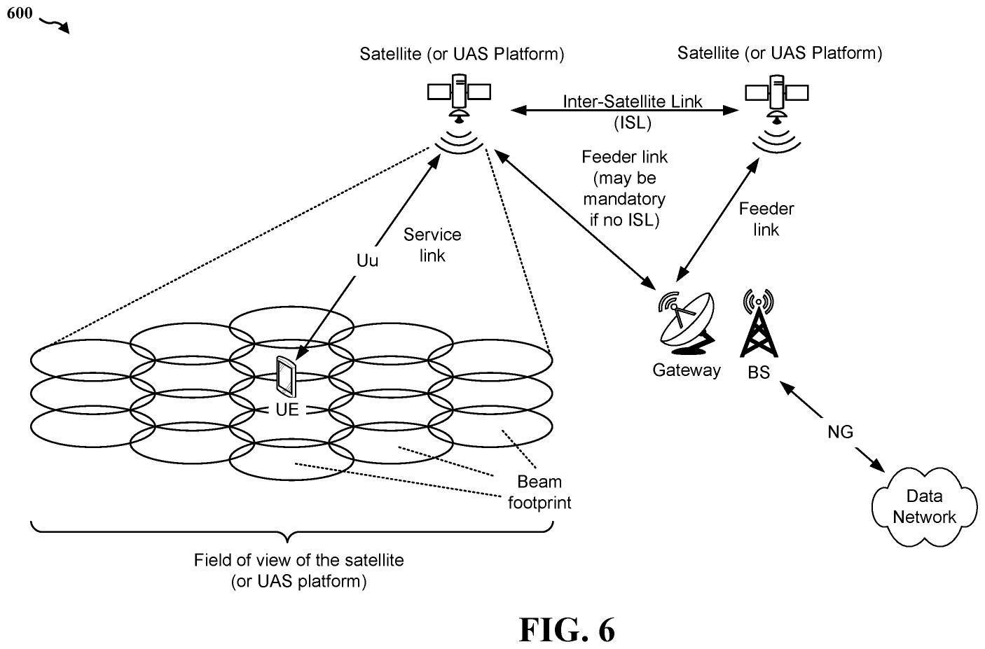

FIG. 6 is a diagram 600 illustrating an example of an NTN architecture based on a regenerative payload in accordance with various aspects of the present disclosure. In some examples, an NTN network may include at least one satellite with a regenerative payload, enabling the satellite to be a distributed unit (DU), or a full base station supporting a satellite-enabled new radio, radio access network (NR-RAN). For example, for a satellite with regenerative payload, the satellite may regenerate incoming signals with signal-processing techniques such as demodulation, decoding, switching, encoding, and modulation before transmission, which may improve division of spectrum. In addition, a satellite with a regenerative payload may include on-board processing (e.g., a digital transparent processor (DTP) or a fully regenerative (FR) transponder). In some examples, inter-satellite links (ISLs) may be established between satellites with regenerative payloads for communications, which may increase the geographical coverage of the receiving ground station/user terminal.

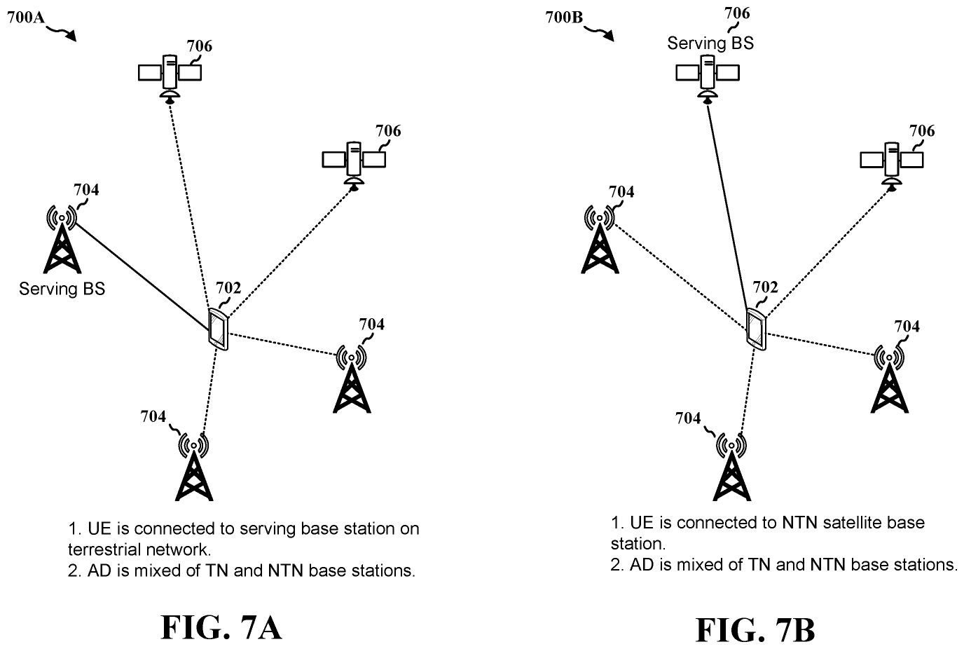

In some examples, a communication network may include both an NTN and a terrestrial network (TN). In other words, a segment of a communication network may include non-terrestrial device(s) (e.g., NTN base stations) and another segment of the communication work may include terrestrial device(s) (e.g., TN/ground base stations). For example, FIGS. 7A and 7B are diagrams 700A and 700B illustrating examples of a network that includes both NTN and TN devices in accordance with various aspects of the present disclosure. A network may include one or more TN devices 704 (e.g., ground base stations and/or TRPs) and one or more NTN devices 706 (e.g., satellites and/or aircrafts), where a UE 702 in a positioning session may transmit or receive signals (e.g., PRSs, SRSs, etc.) with both TN devices 704 and NTN devices 706. In some examples, as shown by the diagram 700A, a serving base station may be a TN base station, such that the UE 702 may connect to the serving base station via a TN network. In other examples, as shown by the diagram 700B, the serving base station may be an NTN satellite base station, such that the UE 702 may connect to the NTN satellite base station via an NTN network. In both scenarios, the assistance data (AD) associated with the UE positioning session may include a mixed of TN and NTN base stations. For purposes of the present disclosure, a base station that is associated with an NTN device (e.g., a satellite, an aircraft, or an UAS platform, etc.) may be referred to as an “NTN base station,” an “NTN satellite base station,” and/or an “NTN base station satellite.” On the other hand, a base station that is located on the earth may be referred to as an “TN base station” and/or a “terrestrial base station.”

Each NTN base station may move with different speeds, and the coverage of the NTN base station on the earth may keep on changing. In some examples, the change in the NTN base station may be deterministic and known at an LMF level. For example, Table 3 below shows examples of NTN scenarios versus delay constraints:

TABLE 3
Examples of NTN scenarios versus delay constraints

| | NTN scenarios | | | | | |
|---|---|---|---|---|---|---|
| | A | B | C1 | C2 | D1 | D2 |
| | GEO | GEO | LEO | | LEO | |
| | trans- | regen- | trans- | | regen- | |
| | parent | erative | parent | | erative | |
| | payload | payload | payload | | payload | |
| Satellite | 35786 km | | 600 km | | | |
| altitude | | | | | | |
| Relative speed | negligible | | 7.56 km per second | | | |
| of Satellite | | | | | | |
| with respect | | | | | | |
| to earth | | | | | | |
| Min elevation | 10° for service link and 10° for feeder link | | | | | |
| for both feeder | | | | | | |
| and service | | | | | | |
| links | | | | | | |
| Typical Min/ | 100 km/3500 km | | 50 km/1000 km | | | |
| Max NTN | | | | | | |
| beam foot print | | | | | | |
| diameter | | | | | | |
| (note 1) | | | | | | |
| Maximum | 541.46 ms | 270.73 ms | 25.77 ms | | 12.89 ms | |
| propagation | (Worst | | | | | |
| delay | case) | | | | | |
| contribution to | | | | | | |
| the Round-Trip | | | | | | |
| Delay on the | | | | | | |
| radio interface | | | | | | |
| between the | | | | | | |
| gNB and the | | | | | | |
| UE | | | | | | |
| Minimum | 477.48 ms | 238.74 ms | 8 ms | | 4 ms | |
| propagation | | | | | | |
| delay | | | | | | |
| contribution to | | | | | | |
| the Round-Trip | | | | | | |
| Delay on the | | | | | | |
| radio interface | | | | | | |
| between the | | | | | | |
| gNB and the | | | | | | |
| UE | | | | | | |

| Maximum | Negligible | Up to +/−93.0 | Up to +/−47.6 |
|---|---|---|---|
| Delay variation | | μs/sec | μs/sec |
| as seen by | | (Worst | |
| the UE | | case) | |
| (note 2) | | | |

(note 1):
The beam foot print diameter is indicative. The diameter depends on the orbit, earth latitude, antenna design, and radio resource management strategy in a given system.
(note 2):
The delay variation measures how fast the round-trip delay (function of UE-satellite-NTN gateway distance) varies over time when the satellite moves towards/away from the UE. It is expressed in μs/s and is negligible for GEO scenario
NOTE 3:
Speed of light used for delay calculation is 299792458 m/s.

As shown by Table 2 and Table 3, multiple types or combinations of satellite networks may be configured for an NTN, such as GEO satellites, LEO satellites, and HAPS. Compared to TN, NTN network satellite may cover much broader ground area. For example, a TN base station may have a coverage distance (e.g., a transmission/reception (Tx/Rx) range) of approximately 5-8 km, whereas a GEO satellite may have a coverage distance of approximately 100-3500 km and a LEO satellite may have a coverage distance of approximately 50-1000 km, etc. As such, in some scenarios, an NTN satellite may cover multiple countries at a time. However, a network may be specified to serve a UE in a specific country based on that country's policies. Thus, the network may be specified to know the location of the UE. For example, an NTN satellite may have a coverage distance of 2000 km that covers three countries with different network policies, where the NTN satellite may be specified to serve a UE in a first country based on a first network policy, serve a UE in a second country based on a second network policy, and not to serve a UE in a third country, etc.

In some network implementations (e.g., 5G NR), a network entity (e.g., a base station, a network server, etc.) may be configured to broadcast a system information block (SIB) 19 (SIB19), where the broadcasted SIB19 may contain satellite assistance information that may enable a UE to connect to one or more satellites. For example, an SIB19 may include an information element (IE) ephemeris information (e.g., ephemerisInfo-r17) that indicates the position and motion of one or more satellites. In another example, an SIB19 may include timing address IEs (e.g., ta-Info-r17) that provides handling timing offset for long delay and/or IE that specifies handling a long delay for HARQ due to long distance between a UE and a base station (e.g., DL-DataToUL-ACK-v1700), etc. Typically, satellite neighbors may be defined for a set of cells that are at the coverage edge of a cellular network footprint. After a UE successfully decodes the SIB19 broadcasted from a network entity, the UE may be able to access satellite services depending on the specification of the UE (e.g., accessing to an NTN as described in connection with FIGS. 5 and 6).

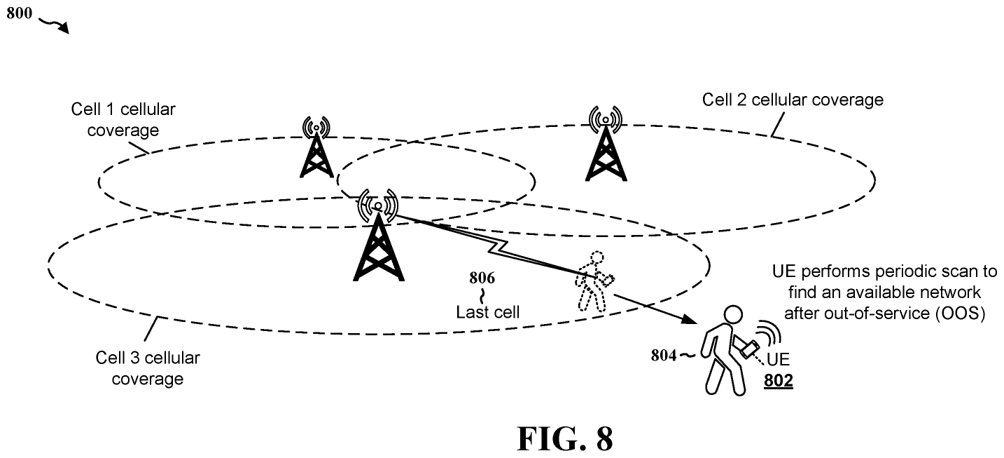

FIG. 8 is a diagram 800 illustrating an example of a UE goes into out-of-service (OOS) due to lack of cellular coverage in accordance with various aspects of present disclosure. As shown at 804, in some scenarios, a UE 802 may go into out-of-service (OOS) (e.g., receive an OOS notification) due to lack of cellular coverage (e.g., when the UE 802 is operating in a terrestrial network). In other words, the connection between the UE 802 and a network (e.g., via a base station/TRP or a set of base stations/TRPs) may become disconnected after the UE 802 moves out of the coverage area of the network. After the UE 802 becomes OOS, the UE 802 may be configured to (e.g., by default) perform periodic scans to find available network signals (e.g., new cell(s) to camp on), so that the UE may latch back to an available network. However, as shown at 806, there could be instances where the cell (e.g., cell 3) from which the UE 802 declares OOS may be the last cell in the coverage footprint (e.g., last cell of a network). Thus, even though the UE 802 may search/scan for new/alternative cell(s), it may be very difficult or impossible for the UE 802 to successfully find a suitable/connectable cell. For example, when the user of the UE 802 enters into a forest or into a deep mountain region and the UE 802 becomes OOS, it may be very unlikely for the UE 802 to find cellular network coverage. In addition, if the user of the UE 802 is lost in the forest or in the deep mountain region, not only does the user may not be able to find his/her route back, the user may also not be able to call for help due to the UE 802 being OOS.

Aspects presented herein may enable a UE to guide its user to return to an area with cellular coverage when the UE is about to become OOS (e.g., disconnect from a network, which may include a set of network entities such as base stations) and/or after the UE becomes OOS. For example, aspects presented herein may enable a UE to record a set of locations with good cellular coverages (e.g., with communication link/channel quality above a quality threshold). Then, if the UE becomes OOS, the UE may indicate to its user about at least one last known location (or a closest known location) with the good cellular coverage (e.g., selected from the recorded set of locations), such that the user may have access to the network again by taking the UE to the indicated last known location. As such, aspects presented herein provide a cost-effective way to enhance the safety of users that are out of cellular coverage of available networks. For purposes of the present disclosure, a cellular coverage may refer to a geographical area covered by a network of a service provider. Within this area, a UE may have access to the service(s) provided by the network (or a partner network), such as completing a call or accessing the Internet. A good cellular coverage may refer to the channel quality/condition between the UE and the network (or the cell) is above a quality/condition threshold. Out-of-service (OOS) may refer to a UE that is not within the cellular coverage or does not have access to service(s) provided by the network (and partner network(s)), or that the connection between the UE and the network (and partner network(s)) falls below certain threshold.

In one aspect of the present disclosure, the neighbor-cell definitions of a deployed network sector (e.g., a base station sector, a gNB sector, etc.) may have the capability to indicate if a cell/sector is deployed in a dense coverage area and/or at a coverage edge area of the network.

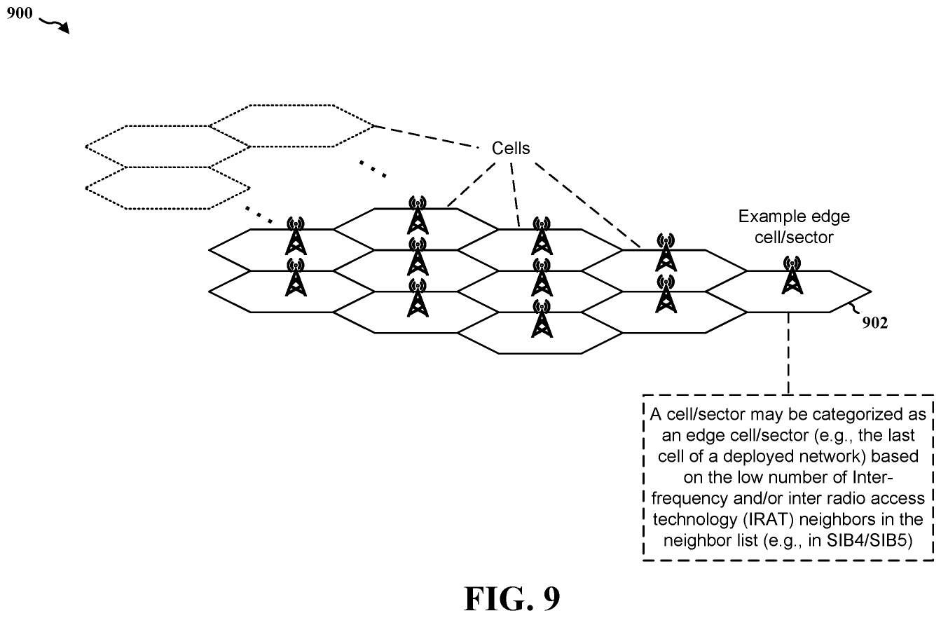

FIG. 9 is a diagram 900 illustrating an example edge cell/sector in accordance with various aspects of the present disclosure. In one example, as shown at 902, a network cell/sector (e.g., a base station cell, a gNB cell, etc.) may be categorized as an edge cell/sector (e.g., the last cell of a deployed network) based on the low number of inter-frequency neighbor(s) and/or inter-radio access technology (IRAT) neighbor(s) in the neighbor list (e.g., in SIB4 and/or SIB5, etc.). In some examples, these edge cells/sectors may have just the co-located cells defined as neighbors, the neighbor list may be non-exhaustive, and at times the total number of neighbors may be very little (e.g., less than ten neighbor cells (neighbor cells <10, 100, etc.)). For purposes of the present disclosure, the term edge cell/sector may also be referred to, and used interchangeably with, “coverage edge cell/sector,” “cell/sector edge,” and/or “cell/sector edge coverage,” etc. In some aspects, an “edge cell” may refer to an edge of a cell or “cell edge” (i.e., a coverage limit or threshold of a cell).

In addition, for edge cells/sectors, the reselection and/or handover (HO) thresholds may be configured to be kept aggressive to trigger early reselection and/or HO to the fallback coverage (e.g., to an IRAT neighbor) so as to ensure the cell coverage is extended for the UE. The reselection threshold and/or the HO threshold may be any threshold value that enables UEs to perform early transition/HO/reselection to fallback coverage. For example, if 5G NR is the latest RAT and the fallback coverage would be LTE 4G/3G, during edge cell, the network may want to ensure a UE falls back to 4G/3G as 4G/3G may have already been widely deployed as compared to the 5G RAT. Also, an IRAT neighbor may refer to any RAT (e.g., LTE, WCDMA, GSM, etc.) neighbor that is a fall back coverage. As such, in one example, a UE may be configured to (intelligently) utilize this information to detect/identify that a current cell is having deviant threshold(s) and categorize the current cell as an edge cell. In other words, a UE may be able to detect, identify or determine whether a cell/sector is likely an edge cell/sector based on the reselection/HO thresholds associated with the cell (e.g., obtained via SIB4/SIB5 broadcasted from the cell). In some examples, if the fallback coverage also becomes bad (e.g., the communication link/channel quality falls below a threshold), the UE may end up in the OOS mode. Thus, in one aspect of the present disclosure, a UE may utilize this information to estimate about the upcoming possibility of UE going to be OOS.

In another aspect of the present disclosure, a UE may be configured to maintain a database that includes a set of locations with cellular coverages (e.g., with cellular coverages above a channel quality threshold) or maintain at least the last known cellular coverage area of the UE before the UE moves to OOS. Then, in response to the UE becoming/declaring OOS, the UE may indicate a location with cellular coverage to its user, which may be the last known coverage area or a closest known coverage area, etc.

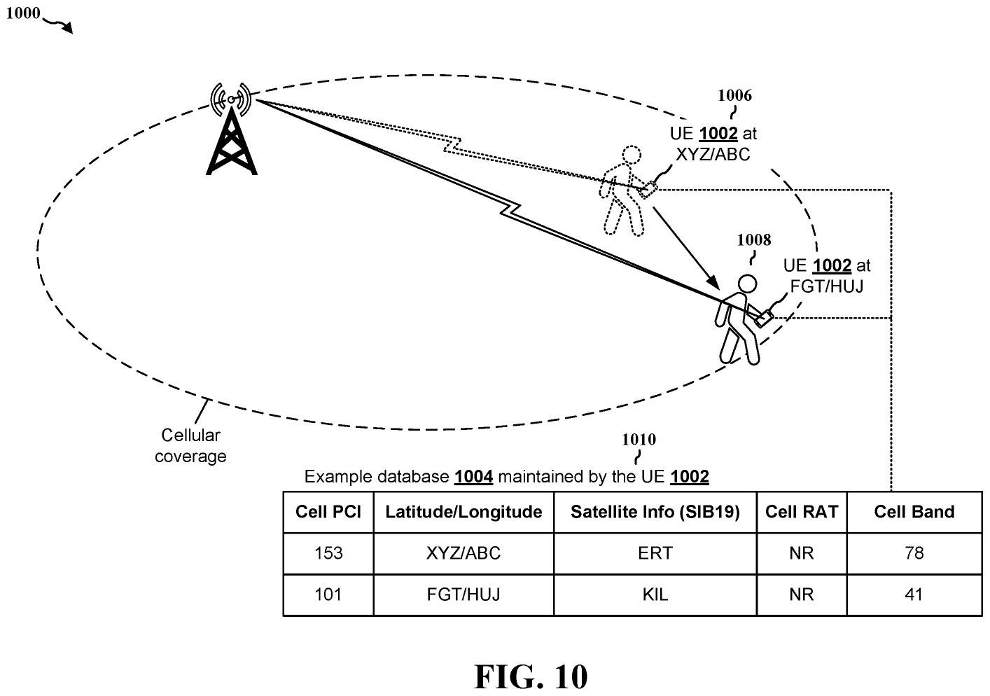

FIG. 10 is a diagram 1000 illustrating an example of a UE maintaining a database that includes a set of locations with cellular coverages in accordance with various aspects of the present disclosure. In one example, a UE 1002 may be configured to maintain a database that includes a set of locations with cellular coverages (e.g., with good cellular coverages, has access to a network (e.g., via a base station/TRP associated with the network) with channel quality above a quality threshold, etc.). For example, as shown at 1006, when the UE 1002 is at a first location (e.g., at latitude/longitude coordinates XYZ/ABC) with cellular coverages, the UE 1002 may record this first location into its database. Then, as shown at 1008, when the UE 1002 is at a second location (e.g., at latitude/longitude coordinates FGT/HUJ) with cellular coverages, the UE 1002 may record this second location into its database. The UE 1002 may be configured to repeat this recording process periodically (e.g., every X minutes), aperiodically, and/or based on meeting certain conditions or a set of pre-defined rules.

For example, the UE 1002 may be configured to record its locations with cellular coverages when the UE 1002 detects that the UE 1002 is at an edge cell/sector (e.g., based on the reselection/HO thresholds associated with the cell as described in connection with FIG. 9). As a UE that is at an edge cell/sector is more likely to be OOS, configuring the UE to record its location(s) when the UE 1002 detects that it is at an edge cell/sector may reduce power consumption at the UE 1002 (compared to recording the locations periodically). In one example, the UE 1002 may also be able to determine/estimate whether it is likely at an edge cell/sector based on the random-access channel (RACH) preamble index associated with the cell. For example, typically longer RACH preambles may be used for higher coverage deployment scenarios and shorter RACH preambles may be used for lower coverage deployment scenarios, etc. Thus, based on the RACH preamble index, the UE 1002 may be configured to intelligently categorize if the cell is deployed for dense urban area coverage or rural area coverage (which is more likely to be an edge cell).

In another example, the UE 1002 may be configured to record its last known location with cellular coverages when the UE 1002 detects/predicts that it is likely/soon to be OOS. For example, the UE 1002 may be configured to record its last known location with cellular coverages when it detects that the data rate (between the UE 1002 and the network) falls below a data rate threshold, or that the channel quality (e.g., reference signal received power (RSRP), reference signal received quality (RSRQ), and/or received signal strength indicator (RSSI), etc.) falls below a channel quality threshold, etc. This may further reduce the power consumption at the UE 1002.

In one example, as shown at 1010, the database 1004 may include various information elements/fields, such as the physical cell identifier (PCI) of the cell, the latitude and longitude coordinates of the UE 1002, satellite information or non-terrestrial network (NTN) information decoded from a SIB19 if the cell is configured with SIB19 (as described in connection with FIGS. 5, 6, 7A, and 7B), the RAT that is associated with the cell/network (e.g., NR, LTE, etc.), the bandwidth of the cell, or a combination thereof.

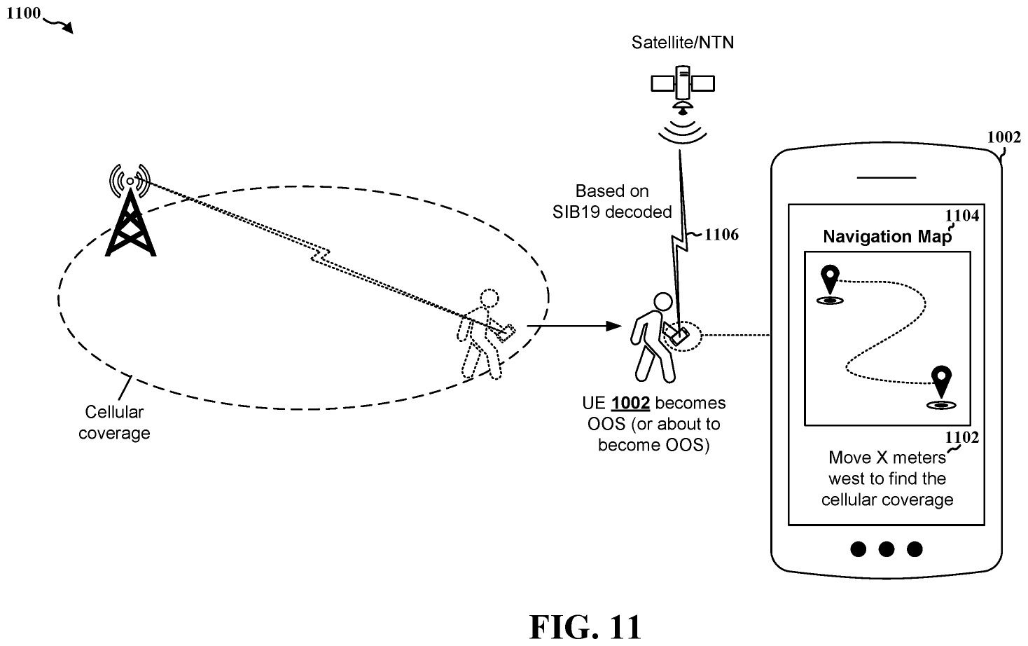

FIG. 11 is a diagram 1100 illustrating an example of a UE indicating a last known location with cellular coverage to a user in accordance with various aspects of the present disclosure. After the UE 1002 maintains the database that includes a set of locations with cellular coverages (or at least a last known location/area with cellular coverage), the UE 1002 may indicate/notify at least one location with cellular coverage to its user when the UE 1002 detects that it is OOS or is about/soon to be OOS (e.g., the channel quality falls below a quality threshold), and/or in response to the user's request (e.g., the user may determine that current channel quality is not good and wants to know which location(s) may provide better/improved channel conditions).

In one example, as shown at 1102, an indication/notification from the UE 1002 indicating a location with cellular coverage may include a text instruction instructing the user to move to certain direction(s) and certain distance(s) (and/or displaying latitude and longitude coordinates information of the location). In another example, as shown at 1104, the indication/notification may include a visual display that navigates the user to the location with cellular coverage (e.g., via offline maps). For example, a database table (e.g., the database 1004 shown at 1010 of FIG. 10) may be displayed in the maps (e.g., by utilizing the offline maps information). Then, the current location of the user and the available last known cellular coverage regions may be displayed. If satellite information is available (e.g., SIB19), the UE 1002 may also indicate the availability of satellite communication. Based on display the information (e.g., directions, latitude/longitude coordinates, etc.) of the last known coverage area to the user, the user may comfortably be navigated back to the cellular coverage area and have access to voice/data services. In another example, the indication/notification may include an audio format that navigates the user to the location with cellular coverage based on voice instruction(s). For purposes of the present disclosure, the text notification, visual display, and audio format may be collectively be referred to as an “user interface.” For example, the UE 1002 may indicate a location with cellular coverage via a user interface, which may include a text instruction, visual display of a map, and/or an audio instruction, etc.

In one example, if map data (e.g., offline maps or data/information associated with maps) for the region in which the UE 1002 is located is available, the UE 1002 may be configured to download offline maps for the region in a specified way to ensure the map tiles which belong to/close to the “in service area” are given a higher priority than map tiles that are further away from the service area. For example, map tiles that are closer to the current location of the UE 1002 may be given a higher downloading priority compared to map tiles that are further away from the current location of the UE 1002.

In another example, after the UE 1002 detects a cell is configured with a SIB19 (e.g., is broadcasting a SIB19 that includes satellite information), the UE 1002 may also include/update the satellite information in its database 1004 along with the cell information and latitude/longitude information, such as shown at 1010 of FIG. 10 (e.g., under a satellite info SIB19 field).

In another example, after the UE 1002 declares OOS, the UE 1002 may server/provide a notification to its user about the last known coverage area. In some examples, this notification may include multiple locations with cellular coverages, and the user may choose a suitable/desired location from the multiple locations, and the UE 1002 may navigate the user to this chosen location. For example, the UE 1002 may display multiple locations to its user, and the user may select a location from the multiple locations to be navigated by the UE 1002.

In another aspect of the present disclosure, as shown at 1106, if the cell in which the UE 1002 records its location(s) also provide a SIB19 that includes neighbor satellite information (and the UE 1002 is able to successfully decode the SIB19), the UE 1002 may also use this neighbor satellite information to connect to at least a satellite or an NTN after the UE 1002 becomes OOS with the cell/network. On the other hand, if the cell in which the UE 1002 records its location(s) is not configured with SIB19 (e.g., does not broadcast SIB19), the neighbor list of the cell may be configured to be limited to just a couple of cells. In general, cell(s) residing at the edge of a cellular network coverage may have a limited neighbor cells such as shown by FIG. 9. For purposes of the present disclosure, co-located same frequency cell(s) may be defined as intra-frequency neighbor(s), co-located different frequency cell(s) may be defined as inter-frequency neighbor(s), and co-located different RAT cell(s) may be defined as the IRAT neighbor(s).

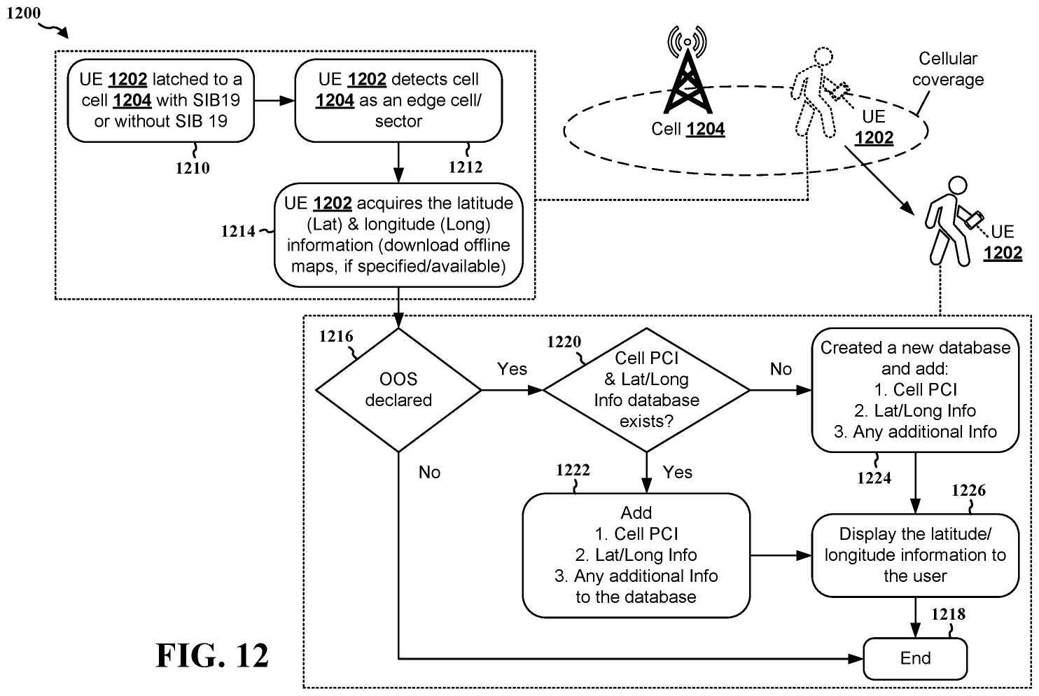

FIG. 12 is a block diagram 1200 illustrating an example of enabling a UE to guide its user to return to cellular coverage in accordance with various aspects of the present disclosure. The numberings associated with the block diagram 1200 do not specify a particular temporal order and are merely used as references for the block diagram 1200.

At 1210, a UE 1202 (e.g., the UE 1002) may latch to a cell 1204, such as while the UE 1202 is within the cellular coverage of the cell 1204. If the cell 1204 is associated with (e.g., broadcasting) a SIB19, the UE 1202 may also be configured to download and decode the SIB19, and store the decoded information (e.g., information related to one or more satellites) in a database (e.g., the database 1004).

At 1212, the UE 1202 may detect whether the cell 1204 is an edge cell/sector, such as described in connection with FIGS. 8 and 9. For example, the UE 1202 may determine whether the cell 1204 is an edge cell/sector based on whether the cell 1204 is a last cell of a network (e.g., a set of network entities or base stations), based on the number of inter-frequency or inter-IRAT neighbors of the cell 1204 below a threshold number, based on the reselection and/or HO thresholds associated with the cell 1204, based on a data rate below a rate threshold or a channel quality below a quality threshold (e.g., from the perception of the UE 1202), and/or based on the length of the RACH preamble broadcasted by the cell 1204 below a length threshold, etc.

At 1214, in response to detecting that the UE 1202 is an edge cell/sector, the UE 1202 may acquire/record its location (e.g., its current location), such as its latitude and longitude coordinates information (Lat/Long Info) and the cell ID of the cell 1204 (e.g., as described in connection with 1010 of FIG. 10). In some examples, the UE may determine its location using GNSS-based positioning and/or network-based positioning (e.g., as described in connection with FIG. 4). In addition, if the UE 1202 has access to maps of its location (e.g., access to a map server/map database), the UE 1202 may also be configured to download offline maps for its location (and/or locations in proximity to the UE), where maps closer to the current location of the UE 1202 may be given a higher download priority compared to maps that are further away from the current location of the UE 1202.

At 1216, the UE 1202 may determine whether the UE 1202 meets one or more condition(s) specified for declaring that the UE 1202 is OOS (or soon to be OOS). For example, in some scenarios, the UE 1202 may determine it is OOS if the channel quality between the UE 1202 and the cell 1204 (or the network associated with the cell 1204) falls below a channel quality threshold. In other scenarios, the UE 1202 may determine it is OOS when the UE 1202 is unable to establish a connection with (or latch on) any available networks. If the UE 1202 determines that it does not meet condition(s) specified for declaring the UE 1202 is OOS, the UE 1202 may take no actions (e.g., proceed to the end at 1218). On the other hand, if the UE 1202 determines that it meets condition(s) specified for declaring the UE 1202 is OOS, then the UE 1202 may declare it is OOS.

At 1220, if the UE 1202 declares it is OOS, the UE 1220 may verify whether there is a database (e.g., the database 1004) for known locations with cellular coverages. If there is a database for known locations with cellular coverages, at 1222, the UE 1202 may add the location information associated with the cell 1204 (e.g., acquired at 1214) to the database, such as the PCI of the cell 1204 and/or the latitude and longitude coordinates of the UE 1202 when the UE 1202 is within the cellular coverage of the cell 1204, etc. On the other hand, if there is no database for known locations with cellular coverages, at 1224, the UE 1202 may create a new database and add these information (e.g., location information associated with the cell 1204) to the database.

At 1226, the UE 1202 may provide or display at least one location with cellular coverage to its user (e.g., the latitude and longitude information for at least one location), such as via a user interface (e.g., based on a visual format, an audio format, etc.), where the at least one location may be a last known location of the UE 1202 with a cellular coverage or a closest location to the UE 1202 with cellular coverage (e.g., selected from the database). For example, the UE 1202 may provide/display the latitude and longitude coordinates of the location to the user (e.g., on the screen of the UE 1202), provide/display a directional guidance for moving towards the location, and/or provide/display a distance between a current position of the UE 1202 and the location, and/or provide/display a navigation map (e.g., based on the offline maps downloaded at 1214 is available) that guides the user from the current position of the UE 1202 to the location, etc. After the UE 1202 reaches the location, then the UE 1202 may proceed to the end at 1218.

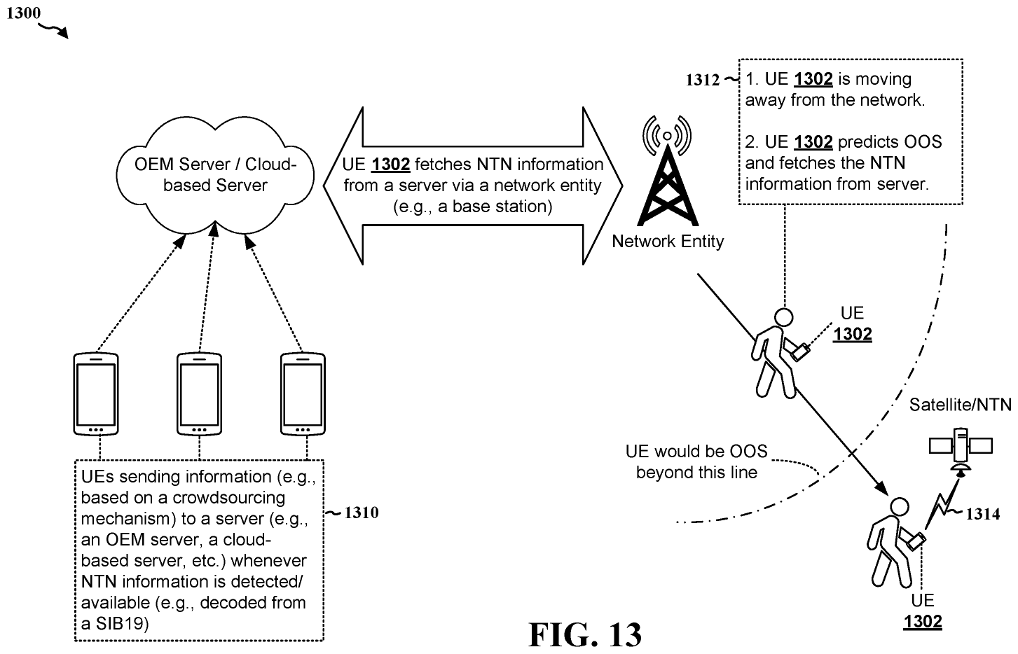

FIG. 13 is a diagram 1300 illustrating an example of enabling a UE to fetch/download NTN information from a server in accordance with various aspects of the present disclosure. In another aspect of the present disclosure, when a UE detects that the current cell is an edge cell (e.g., as described in connection with FIGS. 9 and 12), the UE may be configured to communicate with a server (e.g., an original equipment manufacturer (OEM) key performance indicator (KPI) server, a location server, a cloud-based server, etc.) which stores/has information about an NTN constellation (e.g., for communication between a UE and one or more satellites as described in connection with FIGS. 5 and 6).

For example, as shown at 1310, a group of UEs may be configured to report known NTN information (e.g., obtained from SIB19, from location server, etc.) to a server whenever available (e.g., a crowdsourcing mechanism may be used by the server for collecting NTN information from the UEs). Then, as shown at 1312, when any UE, such as a UE 1302 (e.g., the UE 1002, 1202), predicts a possible out-of-service (OOS) occurrence, the UE 1302 may be configured to fetch/download the NTN information from the server (e.g., the NTN information associated with its location/cell). As shown at 1314, if the UE 1302 becomes OOS, the UE 1302 may establish a communication with at least one satellite associated with the NTN and have access to the network based on the fetched/downloaded NTN information (e.g., as described in connection with FIGS. 5 and 6). With such configuration/implementation, the UE 1302 may not be specified to rely upon the presence of SIB19 being broadcasted (or) not broadcasted by a network entity (e.g., a base station, a gNB, etc.) as the UE 1302 may be able to get the information about available NTN constellation(s) from the server.

In another example, based on the radio frequency (RF) conditions, the trajectory of the UE 1302 (e.g., moving towards a cell or moving away from the cell) may be considered during the OOS detection and/or for determining whether to download offline maps. For example, if the RF conditions (e.g., channel conditions) between the UE 1302 and the cell (or the network) are varying in a degrading manner, it may imply that the UE 1302 is moving away from the cell. As such, the UE 1302 may be triggered to initial the OOS detection procedure, to determine that it is about to become OOS, and/or to download the offline maps, etc. On the other hand, if the RF conditions are varying in an improving manner, it may imply UE 1302 is moving towards the cell, and the UE 1302 may be prevented from initiating the OOS detection procedure and/or downloading the offline maps, etc. (e.g., to conserve power).

Aspects described in connection with FIGS. 9 to 11 may be jointly used on a UE (e.g., the UE 1002, 1202, 1302) with an aim to detect OOS condition(s) and provide the user of the UE with a last known/closest coverage location (and download the offline maps if specified when the UE is in a good coverage area), and also when the cell includes SIB19 transmission/broadcasting. On the other hand, if the cell in which the UE latches to is not configured with a SIB19, aspects described in connection with FIGS. 9, 10 and 13 may be jointly used on the UE instead. In other examples, aspects described in connection with FIGS. 10, 11, and 13 may be combined to gracefully handle scenarios when the NTN information from a carrier's broadcast of SIB19 (e.g., a first service provider) is not aligned with the NTN subscription (e.g., a second service provider) of the UE.

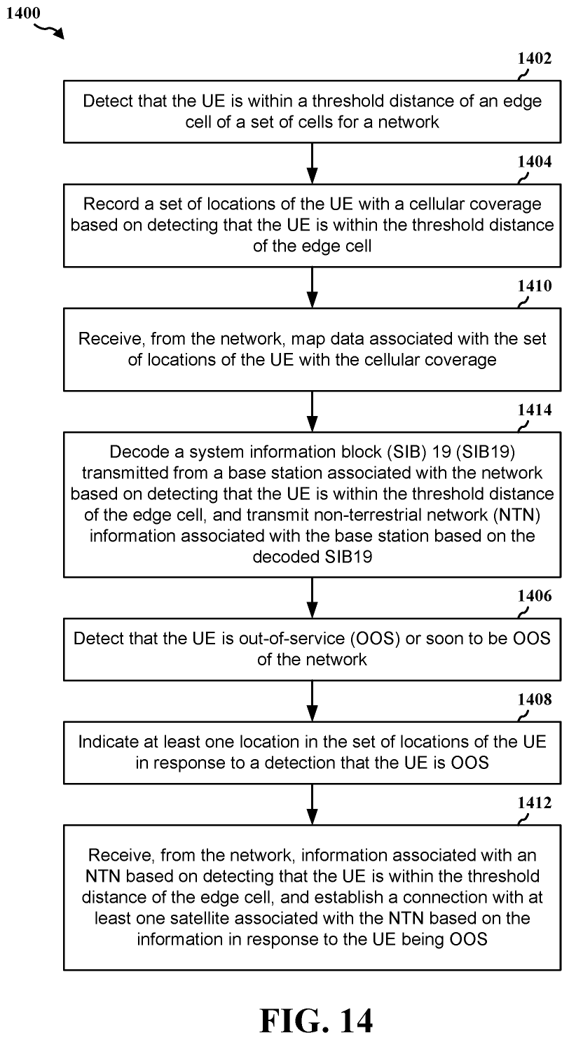

FIG. 14 is a flowchart 1400 of a method of wireless communication. The method may be performed by a UE (e.g., the UE 104, 510, 702, 802, 1002, 1202, 1302; the apparatus 1604). The method may enable the UE to guide its user to at least one location with cellular coverage after the UE declares OOS.

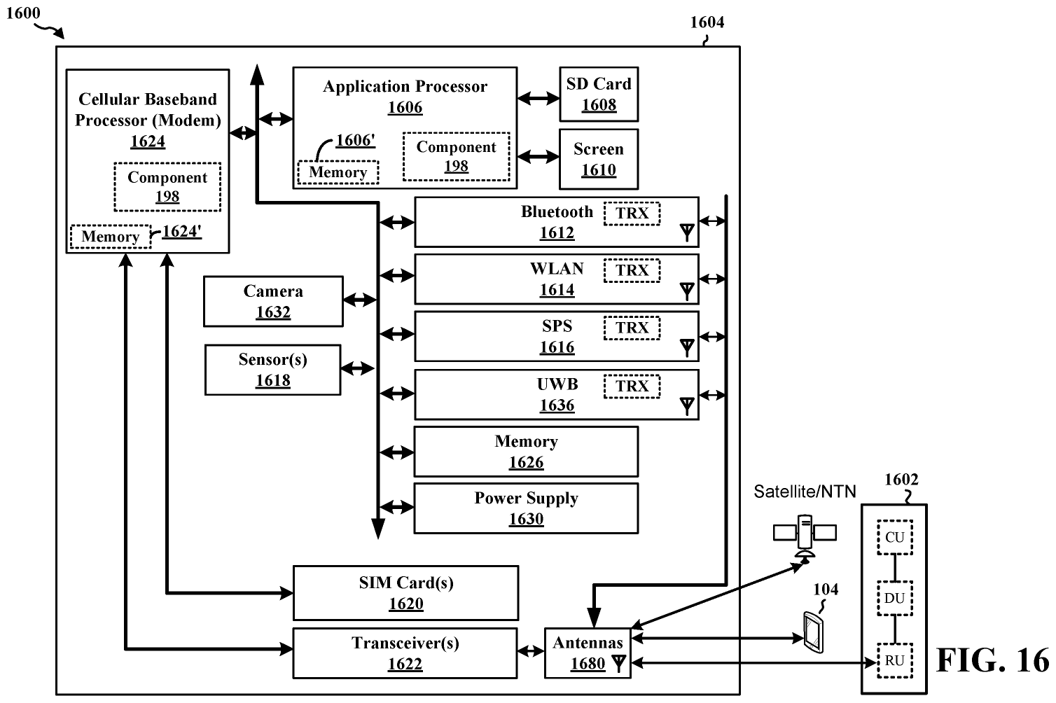

At 1402, the UE may detect that the UE is within a threshold distance of an edge cell of a set of cells for a network, such as described in connection with FIGS. 8, 9, and 12. For example, as discussed in connection with 1212 of FIG. 12, the UE 1202 may detect the cell 1204 in which it latches to is an edge cell. The means for detecting that the UE is within a threshold distance of an edge cell may be performed by, e.g., the last cellular coverage navigation component 198, the application processor 1606, the cellular baseband processor 1624, and/or the transceiver(s) 1622 of the apparatus 1604 in FIG. 16.

In one example, the edge cell may be detected based on: a last cell of the set of cells for the network, a number of inter-frequency or IRAT neighbors below a threshold number, a reselection threshold or a HO threshold is below a specified number, a data rate below a rate threshold, a length of a RACH preamble below a length threshold, or a combination thereof.

At 1404, the UE may record a set of locations of the UE with a cellular coverage based on detecting that the UE is within the threshold distance of the edge cell, such as described in connection with FIGS. 10 and 12. For example, as discussed in connection with 1214 of FIG. 12, the UE 1202 may acquire and record its latitude and longitude coordinates information after the UE 1202 detects that it is at an edge cell. The means for recording a set of locations of the UE may be performed by, e.g., the last cellular coverage navigation component 198, the application processor 1606, the cellular baseband processor 1624, and/or the transceiver(s) 1622 of the apparatus 1604 in FIG. 16.

In one example, the set of locations of the UE may correspond to a set of latitude and longitude coordinates of the UE. In some implementations, to indicate the at least one location in the set of locations of the UE, the UE may provide, via a user interface, the set of latitude and longitude coordinates for the at least one location, a directional guidance for moving towards the at least one location, a distance between a current position of the UE and the at least one location, or a combination thereof. In some implementations, to indicate the at least one location in the set of locations of the UE, the UE may transmit, to the network, an indication of the set of latitude and longitude coordinates for the at least one location. In some implementations, the UE may store the set of latitude and longitude coordinates for the at least one location.

In another example, to record the set of locations of the UE with the cellular coverage, the UE may record a PCI of the at least one cell of the set of cells, a set of latitude and longitude coordinates of each location in the set of locations of the UE, satellite information or NTN information decoded from a SIB19, a RAT associated with the network, a bandwidth of the at least one cell of the set of cells, or a combination thereof.

At 1406, the UE may detect that the UE is OOS or soon to be OOS of the network, such as described in connection with FIGS. 11 and 12. For example, as discussed in connection with 1216 of FIG. 12, the UE 1202 may determine whether it is OOS or is about to become OOS. The means for detecting that the UE is OOS may be performed by, e.g., the last cellular coverage navigation component 198, the application processor 1606, the cellular baseband processor 1624, and/or the transceiver(s) 1622 of the apparatus 1604 in FIG. 16.

In one example, to detect that the UE is OOS of the at least one cell, the UE may predict that the UE is OOS of the at least one cell, determine that a signal strength between the UE and the at least one cell is below a signal threshold, estimate that the UE is moving away from the cellular coverage of the network based on a set of radio frequency (RF) conditions of the UE, determine that the UE meets a set of conditions specified for declaring the UE is OOS, or a combination thereof.

At 1408, the UE may indicate at least one location in the set of locations of the UE in response to a detection that the UE is OOS, such as described in connection with FIGS. 11 and 12. For example, as discussed in connection with 1226 of FIG. 12, the UE 1202 may provide the latitude and longitude information of a last known location with cellular coverage to a user in response to the UE declaring OOS. The means for indicating at least one location may be performed by, e.g., the last cellular coverage navigation component 198, the application processor 1606, the screen 1610, the cellular baseband processor 1624, and/or the transceiver(s) 1622 of the apparatus 1604 in FIG. 16.

In one example, as shown at 1410, the UE may receive, from the network, map data associated with the set of locations of the UE with the cellular coverage, such as described in connection with FIGS. 11 and 12. For example, as discussed in connection with 1214 and 1226 of FIG. 12, the UE 1202 may download offline maps after the UE 1202 detects it is within an edge cell, and the UE 1202 may navigate the user of the UE 1202 to a location with cellular coverage based on the offline maps. The means for receiving the map data may be performed by, e.g., the last cellular coverage navigation component 198, the application processor 1606, the screen 1610, the cellular baseband processor 1624, and/or the transceiver(s) 1622 of the apparatus 1604 in FIG. 16. In some implementations, to indicate the at least one location in the set of locations of the UE, the UE may provide the at least one location using the map data.

In another example, the at least one location may correspond to a last location of the UE with the cellular coverage (e.g., in this location the UE may have service for all of the set of cells).

In another example, as shown at 1412, the UE may receive, from the network, information associated with an NTN based on detecting that the UE is within the threshold distance of the edge cell, and establish a connection with at least one satellite associated with the NTN based on the information in response to the UE being OOS, such as described in connection with FIG. 13. For example, as shown at 1312, when the UE 1302 predicts that is may be OOS or is within an edge cell, the UE 1302 may fetch NTN information from a server via a base station. Then, as shown at 1314, after the UE 1302 becomes OOS, the UE 1302 may establish a connection with at least one NTN satellite based on the fetched NTN information. The means for receiving information associated with an NTN and/or the means for establishing a connection with at least one satellite may be performed by, e.g., the last cellular coverage navigation component 198, the application processor 1606, the cellular baseband processor 1624, and/or the transceiver(s) 1622 of the apparatus 1604 in FIG. 16.

In another example, as shown at 1414, the UE may decode a SIB19 from a base station associated with the network based on detecting that the UE is within the threshold distance of the edge cell, and transmit NTN information associated with the base station based on the decoded SIB19, such as described in connection with FIG. 13. For example, as shown at 1310, a plurality of UEs may send information to a server (e.g., an OEM server, a cloud-based server, etc.) whenever NTN information is detected/available (e.g., decoded from a SIB19). The means for decoding the SIB19 and/or the means for transmitting the NTN information may be performed by, e.g., the last cellular coverage navigation component 198, the application processor 1606, the cellular baseband processor 1624, and/or the transceiver(s) 1622 of the apparatus 1604 in FIG. 16. In one example, the UE may update satellite information in a database of the UE with current cell information and position information based on the decoded SIB19. In another example, the NTN information may include an NTN constellation.

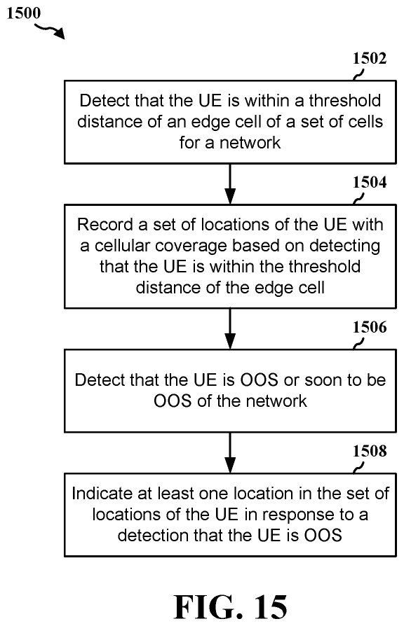

FIG. 15 is a flowchart 1500 of a method of wireless communication. The method may be performed by a UE (e.g., the UE 104, 510, 702, 802, 1002, 1202, 1302; the apparatus 1604). The method may enable the UE to guide its user to at least one location with cellular coverage after the UE declares OOS.

At 1502, the UE may detect that the UE is within a threshold distance of an edge cell of a set of cells for a network, such as described in connection with FIGS. 8, 9, and 12. For example, as discussed in connection with 1212 of FIG. 12, the UE 1202 may detect the cell 1204 in which it latches to is an edge cell. The means for detecting that the UE is within a threshold distance of an edge cell may be performed by, e.g., the last cellular coverage navigation component 198, the application processor 1606, the cellular baseband processor 1624, and/or the transceiver(s) 1622 of the apparatus 1604 in FIG. 16.

In one example, the edge cell may be detected based on: a last cell of the set of cells for the network, a number of inter-frequency or IRAT neighbors below a threshold number, a reselection threshold or a HO threshold is below a specified number, a data rate below a rate threshold, a length of a RACH preamble below a length threshold, or a combination thereof.

At 1504, the UE may record a set of locations of the UE with a cellular coverage based on detecting that the UE is within the threshold distance of the edge cell, such as described in connection with FIGS. 10 and 12. For example, as discussed in connection with 1214 of FIG. 12, the UE 1202 may acquire and record its latitude and longitude coordinates information after the UE 1202 detects that it is at an edge cell. The means for recording a set of locations of the UE may be performed by, e.g., the last cellular coverage navigation component 198, the application processor 1606, the cellular baseband processor 1624, and/or the transceiver(s) 1622 of the apparatus 1604 in FIG. 16.

In one example, the set of locations of the UE may correspond to a set of latitude and longitude coordinates of the UE. In some implementations, to indicate the at least one location in the set of locations of the UE, the UE may provide, via a user interface, the set of latitude and longitude coordinates for the at least one location, a directional guidance for moving towards the at least one location, a distance between a current position of the UE and the at least one location, or a combination thereof. In some implementations, to indicate the at least one location in the set of locations of the UE, the UE may transmit, to the network, an indication of the set of latitude and longitude coordinates for the at least one location. In some implementations, the UE may store the set of latitude and longitude coordinates for the at least one location.

In another example, to record the set of locations of the UE with the cellular coverage, the UE may record a PCI of the at least one cell of the set of cells, a set of latitude and longitude coordinates of each location in the set of locations of the UE, satellite information or NTN information decoded from a SIB19, a RAT associated with the network, a bandwidth of the at least one cell of the set of cells, or a combination thereof.

At 1506, the UE may detect that the UE is OOS or soon to be OOS of the network, such as described in connection with FIGS. 11 and 12. For example, as discussed in connection with 1216 of FIG. 12, the UE 1202 may determine whether it is OOS or is about to become OOS. The means for detecting that the UE is OOS may be performed by, e.g., the last cellular coverage navigation component 198, the application processor 1606, the cellular baseband processor 1624, and/or the transceiver(s) 1622 of the apparatus 1604 in FIG. 16.

In one example, to detect that the UE is OOS of the at least one cell, the UE may predict that the UE is OOS of the at least one cell, determine that a signal strength between the UE and the at least one cell is below a signal threshold, estimate that the UE is moving away from the cellular coverage of the network based on a set of RF conditions of the UE, determine that the UE meets a set of conditions specified for declaring the UE is OOS, or a combination thereof.

At 1508, the UE may indicate at least one location in the set of locations of the UE in response to a detection that the UE is OOS, such as described in connection with FIGS. 11 and 12. For example, as discussed in connection with 1226 of FIG. 12, the UE 1202 may provide/display the latitude and longitude information of a last known location with cellular coverage to a user in response to the UE declaring OOS. The means for indicating at least one location may be performed by, e.g., the last cellular coverage navigation component 198, the application processor 1606, the screen 1610, the cellular baseband processor 1624, and/or the transceiver(s) 1622 of the apparatus 1604 in FIG. 16.

In one example, the UE may receive, from the network, map data associated with the set of locations of the UE with the cellular coverage, such as described in connection with FIGS. 11 and 12. For example, as discussed in connection with 1214 and 1226 of FIG. 12, the UE 1202 may download offline maps after the UE 1202 detects it is within an edge cell, and the UE 1202 may navigate the user of the UE 1202 to a location with cellular coverage based on the offline maps. The means for receiving the map data may be performed by, e.g., the last cellular coverage navigation component 198, the application processor 1606, the screen 1610, the cellular baseband processor 1624, and/or the transceiver(s) 1622 of the apparatus 1604 in FIG. 16. In some implementations, to indicate the at least one location in the set of locations of the UE, the UE may provide the at least one location using the map data.

In another example, the at least one location may correspond to a last location of the UE with the cellular coverage (e.g., in this location the UE may have service for all of the set of cells).

In another example, the UE may receive, from the network, information associated with an NTN based on detecting that the UE is within the threshold distance of the edge cell, and establish a connection with at least one satellite associated with the NTN based on the information in response to the UE being OOS, such as described in connection with FIG. 13. For example, as shown at 1312, when the UE 1302 predicts that is may be OOS or is within an edge cell, the UE 1302 may fetch NTN information from a server via a base station. Then, as shown at 1314, after the UE 1302 becomes OOS, the UE 1302 may establish a connection with at least one NTN satellite based on the fetched NTN information. The means for receiving information associated with an NTN and/or the means for establishing a connection with at least one satellite may be performed by, e.g., the last cellular coverage navigation component 198, the application processor 1606, the cellular baseband processor 1624, and/or the transceiver(s) 1622 of the apparatus 1604 in FIG. 16.

In another example, the UE may decode a SIB19 from a base station associated with the network based on detecting that the UE is within the threshold distance of the edge cell, and transmit NTN information associated with the base station based on the decoded SIB19, such as described in connection with FIG. 13. For example, as shown at 1310, a plurality of UEs may send information to a server (e.g., an OEM server, a cloud-based server, etc.) whenever NTN information is detected/available (e.g., decoded from a SIB19). The means for decoding the SIB19 and/or the means for transmitting the NTN information may be performed by, e.g., the last cellular coverage navigation component 198, the application processor 1606, the cellular baseband processor 1624, and/or the transceiver(s) 1622 of the apparatus 1604 in FIG. 16. In one example, the UE may update satellite information in a database of the UE with current cell information and position information based on the decoded SIB19. In another example, the NTN information may include an NTN constellation.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), an ultra-wideband (UWB) module 1636, one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, the UWB module 1636, and the SPS module 1616 may include an on-chip transceiver (TRX) (or in some cases, just a receiver (RX)). The Bluetooth module 1612, the WLAN module 1614, the UWB module 1636, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see UE 350 of FIG. 3) and include the additional modules of the apparatus 1604.

As discussed supra, the last cellular coverage navigation component 198 may be configured to detect that the apparatus 1604 is within a threshold distance of an edge cell of a set of cells for a network. The last cellular coverage navigation component 198 may also be configured to record a set of locations of the apparatus 1604 with a cellular coverage based on detecting that the apparatus 1604 is within the threshold distance of the edge cell. The last cellular coverage navigation component 198 may also be configured to detect that the apparatus 1604 is OOS or soon to be OOS of the network. The last cellular coverage navigation component 198 may also be configured to indicate at least one location in the set of locations of the apparatus 1604 in response to a detection that the apparatus 1604 is OOS. The last cellular coverage navigation component 198 may be within the cellular baseband processor 1624, the application processor 1606, or both the cellular baseband processor 1624 and the application processor 1606. The last cellular coverage navigation component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, may include means for detecting that the apparatus 1604 is within a threshold distance of an edge cell of a set of cells for a network. The apparatus 1604 may further include means for recording a set of locations of the apparatus 1604 with a cellular coverage based on detecting that the apparatus 1604 is within the threshold distance of the edge cell. The apparatus 1604 may further include means for storing or means for detecting that the apparatus 1604 is OOS or soon to be OOS of the network. The apparatus 1604 may further include means for indicating at least one location in the set of locations of the apparatus 1604 in response to a detection that the apparatus 1604 is OOS.

In one configuration, the edge cell may be detected based on: a last cell of the set of cells for the network, a number of inter-frequency or IRAT neighbors below a threshold number, a reselection threshold or a HO threshold is below a specified number, a data rate below a rate threshold, a length of a RACH preamble below a length threshold, or a combination thereof.

In another configuration, the set of locations of the apparatus 1604 may correspond to a set of latitude and longitude coordinates of the apparatus 1604. In some implementations, the means for indicating the at least one location in the set of locations of the apparatus 1604 may include configuring the apparatus 1604 to provide, via a user interface, the set of latitude and longitude coordinates for the at least one location, a directional guidance for moving towards the at least one location, a distance between a current position of the apparatus 1604 and the at least one location, or a combination thereof. In some implementations, the means for indicating the at least one location in the set of locations of the apparatus 1604 may include configuring the apparatus 1604 to transmit, to the network, an indication of the set of latitude and longitude coordinates for the at least one location. In some implementations the apparatus 1604 may further include means for storing the set of latitude and longitude coordinates for the at least one location.

In another configuration, the means for recording the set of locations of the apparatus 1604 with the cellular coverage may include configuring the apparatus 1604 to record a PCI of the at least one cell of the set of cells, a set of latitude and longitude coordinates of each location in the set of locations of the apparatus 1604, satellite information or NTN information decoded from a SIB19, a RAT associated with the network, a bandwidth of the at least one cell of the set of cells, or a combination thereof.

In another configuration, the means for detecting that the apparatus 1604 is OOS or soon to be OOS of the network may include configuring the apparatus 1604 to predict that the apparatus 1604 is OOS of the at least one cell, determine that a signal strength between the apparatus 1604 and the at least one cell is below a signal threshold, estimate that the apparatus 1604 is moving away from the cellular coverage of the network based on a set of RF conditions of the apparatus 1604, determine that the apparatus 1604 meets a set of conditions specified for declaring the apparatus 1604 is OOS, or a combination thereof.

In another configuration, the apparatus 1604 may further include means for receiving, from the network, map data associated with the set of locations of the apparatus 1604 with the cellular coverage, where the means for indicating the at least one location in the set of locations of the apparatus 1604 may include configuring the apparatus 1604 to display the at least one location using the map data.

In another configuration, the at least one location may correspond to a last location of the apparatus 1604 with the cellular coverage (e.g., in this location the apparatus 1604 may have service for all of the set of cells).

In another configuration, the apparatus 1604 may further include means for receiving, from the network, information associated with an NTN based on detecting that the apparatus 1604 is within the threshold distance of the edge cell, and means for establishing a connection with at least one satellite associated with the NTN based on the information in response to the apparatus 1604 being OOS.

In another configuration, the apparatus 1604 may further include means for decoding a SIB19 from a base station associated with the network based on detecting that the apparatus 1604 is within the threshold distance of the edge cell, and means for transmitting NTN information associated with the base station based on the decoded SIB19. In one implementation, the apparatus 1604 may further include means for updating satellite information in a database of the apparatus 1604 with current cell information and position information based on the decoded SIB19. In another implementation, the NTN information may include an NTN constellation.

The means may be the last cellular coverage navigation component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: detecting that the UE is within a threshold distance of an edge cell of a set of cells for a network; recording a set of locations of the UE with a cellular coverage based on detecting that the UE is within the threshold distance of the edge cell; detecting that the UE is OOS or soon to be OOS of the network; and indicating at least one location in the set of locations of the UE in response to a detection that the UE is OOS.

Aspect 2 is the method of aspect 1, where the edge cell is detected based on: a last cell of the set of cells for the network, a number of inter-frequency or IRAT neighbors below a threshold number, a reselection threshold or a HO threshold is below a specified number, a data rate below a rate threshold, a length of a RACH preamble below a length threshold, or a combination thereof.

Aspect 3 is the method of aspect 1 or 2, where the set of locations of the UE corresponds to a set of latitude and longitude coordinates of the UE.

Aspect 4 is the method of aspect 3, where indicating the at least one location in the set of locations of the UE includes providing, via a user interface, the set of latitude and longitude coordinates for the at least one location, a directional guidance for moving towards the at least one location, a distance between a current position of the UE and the at least one location, or a combination thereof.

Aspect 5 is the method of aspect 3, where indicating the at least one location in the set of locations of the UE includes: transmitting, to the network, an indication of the set of latitude and longitude coordinates for the at least one location.

Aspect 6 is the method of aspect 3, further including: storing the set of latitude and longitude coordinates for the at least one location.

Aspect 7 is the method of any of aspects 1 to 6, where detecting that the UE is OOS of the network includes: predicting that the UE is OOS of the at least one cell, determining that a signal strength between the UE and the at least one cell is below a signal threshold, estimating that the UE is moving away from the cellular coverage of the network based on a set of RF conditions of the UE, determining that the UE meets a set of conditions specified for declaring the UE is OOS, or a combination thereof.

Aspect 8 is the method of any of aspects 1 to 7, further including: receiving, from the network, map data associated with the set of locations of the UE with the cellular coverage, where indicating the at least one location in the set of locations of the UE includes displaying the at least one location using the map data.

Aspect 9 is the method of any of aspects 1 to 8, further including: receiving, from the network, information associated with an NTN based on detecting that the UE is within the threshold distance of the edge cell; and establishing a connection with at least one satellite associated with the NTN based on the information in response to the UE being OOS.

Aspect 10 is the method of any of aspects 1 to 9, further including: decoding a SIB19 from a base station associated with the network based on detecting that the UE is within the threshold distance of the edge cell; and transmitting NTN information associated with the base station based on the decoded SIB19.

Aspect 11 is the method of aspect 10, further including: updating satellite information in a database of the UE with current cell information and position information based on the decoded SIB19.

Aspect 12 is the method of aspect 10, where the NTN information includes an NTN constellation.

Aspect 13 is the method of any of aspects 1 to 12, where recording the set of locations of the UE with the cellular coverage includes recording: a PCI of the at least one cell of the set of cells, a set of latitude and longitude coordinates of each location in the set of locations of the UE, satellite information or NTN information decoded from a SIB19, a RAT associated with the network, a bandwidth of the at least one cell of the set of cells, or a combination thereof.

Aspect 14 is the method of any of aspects 1 to 13, where the at least one location corresponds to a last location of the UE with the cellular coverage.

Aspect 15 is an apparatus for wireless communication at a UE, including: a memory; and at least one processor coupled to the memory and, based at least in part on information stored in the memory, the at least one processor is configured to implement any of aspects 1 to 14.

Aspect 16 is the apparatus of aspect 15, further including at least one of a transceiver or an antenna coupled to the at least one processor.

Aspect 17 is an apparatus for wireless communication including means for implementing any of aspects 1 to 14.

Aspect 18 is a computer-readable medium (e.g., a non-transitory computer-readable medium) storing computer executable code, where the code when executed by a processor causes the processor to implement any of aspects 1 to 14.

What is claimed is:

1. An apparatus for wireless communication at a user equipment (UE), comprising:
a memory; and
at least one processor coupled to the memory, and the at least one processor is configured to:
detect that the UE is within a threshold distance of an edge cell of a set of cells for a network;
record a set of locations of the UE with a cellular coverage based on detecting that the UE is within the threshold distance of the edge cell;
detect that the UE is out-of-service (OOS) or soon to be OOS of the network; and
indicate at least one location in the set of locations of the UE in response to a detection that the UE is OOS.

2. The apparatus of claim 1, wherein the edge cell is detected based on:
a last cell of the set of cells for the network,
a number of inter-frequency or inter-radio access technology (IRAT) neighbors below a threshold number,
a reselection threshold or a handover (HO) threshold is below a specified number,
a data rate below a rate threshold,
a length of a random-access channel (RACH) preamble below a length threshold, or
a combination thereof.

3. The apparatus of claim 1, wherein the set of locations of the UE corresponds to a set of latitude and longitude coordinates of the UE.

4. The apparatus of claim 3, wherein to indicate the at least one location in the set of locations of the UE, the at least one processor is configured to:
provide, via a user interface, the set of latitude and longitude coordinates for the at least one location, a direction for moving towards the at least one location, a distance between a current position of the UE and the at least one location, or a combination thereof.

5. The apparatus of claim 3, wherein to indicate the at least one location in the set of locations of the UE, the at least one processor is configured to:
transmit, to the network, an indication of the set of latitude and longitude coordinates for the at least one location.

6. The apparatus of claim 3, wherein the at least one processor is further configured to:
store the set of latitude and longitude coordinates for the at least one location.

7. The apparatus of claim 1, wherein to detect that the UE is OOS or soon to be OOS of the network, the at least one processor is configured to:
predict that the UE is OOS of the at least one cell,
determine that a signal strength between the UE and the at least one cell is below a signal threshold,
estimate that the UE is moving away from the cellular coverage of the network based on a set of radio frequency (RF) conditions of the UE,
determine that the UE meets a set of conditions specified for declaring the UE is OOS, or
a combination thereof.

8. The apparatus of claim 1, wherein the at least one processor is further configured to:
receive, from the network, map data associated with the set of locations of the UE with the cellular coverage, wherein to indicate the at least one location in the set of locations of the UE, the at least one processor is configured to display the at least one location using the map data.

9. The apparatus of claim 1, wherein the at least one processor is further configured to:
receive, from the network, information associated with a non-terrestrial network (NTN) based on the detection that the UE is within the threshold distance of the edge cell; and
establish a connection with at least one satellite associated with the NTN based on the information in response to the UE being OOS.

10. The apparatus of claim 1, wherein the at least one processor is further configured to:
decode a system information block (SIB) 19 (SIB19) from a base station associated with the network based on the detection that the UE is within the threshold distance of the edge cell; and
transmit non-terrestrial network (NTN) information associated with the base station based on the decoded SIB19.

11. The apparatus of claim 10, wherein the at least one processor is further configured to:
update satellite information in a database of the UE with current cell information and position information based on the decoded SIB19.

12. The apparatus of claim 10, wherein the NTN information includes an NTN constellation.

13. The apparatus of claim 1, wherein to record the set of locations of the UE with the cellular coverage include, the at least one processor is configured to record:
a physical cell identifier (PCI) of the at least one cell of the set of cells,
a set of latitude and longitude coordinates of each location in the set of locations of the UE,
satellite information or non-terrestrial network (NTN) information decoded from a system information block (SIB) 19 (SIB19),
a radio access technology (RAT) associated with the network,
a bandwidth of the at least one cell of the set of cells, or
a combination thereof.

14. The apparatus of claim 1, wherein the at least one location corresponds to a last location of the UE with the cellular coverage.

15. A method of wireless communication at a user equipment (UE), comprising:
detecting that the UE is within a threshold distance of an edge cell of a set of cells for a network;
recording a set of locations of the UE with a cellular coverage based on detecting that the UE is within the threshold distance of the edge cell;
detecting that the UE is out-of-service (OOS) or soon to be OOS of the network; and
indicating at least one location in the set of locations of the UE in response to a detection that the UE is OOS.

16. The method of claim 15, wherein the edge cell is detected based on:
a last cell of the set of cells for the network,
a number of inter-frequency or inter-radio access technology (IRAT) neighbors below a threshold number,
a reselection threshold or a handover (HO) threshold is below a specified number,
a data rate below a rate threshold,
a length of a random-access channel (RACH) preamble below a length threshold, or
a combination thereof.

17. The method of claim 15, wherein the set of locations of the UE corresponds to a set of latitude and longitude coordinates of the UE.

18. The method of claim 17, wherein indicating the at least one location in the set of locations of the UE comprises providing, via a user interface, the set of latitude and longitude coordinates for the at least one location, a directional guidance for moving towards the at least one location, a distance between a current position of the UE and the at least one location, or a combination thereof.

19. The method of claim 17, wherein indicating the at least one location in the set of locations of the UE comprises:
transmitting, for the network, an indication of the set of latitude and longitude coordinates for the at least one location.

20. The method of claim 17, further comprising:
storing the set of latitude and longitude coordinates for the at least one location.

21. The method of claim 15, wherein detecting that the UE is OOS or soon to be OOS of the network comprises:
predicting that the UE is OOS of the at least one cell,
determining that a signal strength between the UE and the at least one cell is below a signal threshold,
estimating that the UE is moving away from the cellular coverage of the network based on a set of radio frequency (RF) conditions of the UE,
determining that the UE meets a set of conditions specified for declaring the UE is OOS, or
a combination thereof.

22. The method of claim 15, further comprising:
receiving, from the network, map data associated with the set of locations of the UE with the cellular coverage, wherein indicating the at least one location in the set of locations of the UE comprises displaying the at least one location using the map data.

23. The method of claim 15, further comprising:
receiving, from the network, information associated with a non-terrestrial network (NTN) based detecting that the UE is within the threshold distance of the edge cell; and
establishing a connection with at least one satellite associated with the NTN based on the information in response to the UE being OOS.

24. The method of claim 15, further comprising:
decoding a system information block (SIB) 19 (SIB19) from a base station associated with the network based on detecting that the UE is within the threshold distance of the edge cell; and
transmitting non-terrestrial network (NTN) information associated with the base station based on the decoded SIB19.

25. The method of claim 24, further comprising:
updating satellite information in a database of the UE with current cell information and position information based on the decoded SIB19.

26. The method of claim 24, wherein the NTN information includes an NTN constellation.

27. The method of claim 15, wherein recording the set of locations of the UE with the cellular coverage includes recording:
a physical cell identifier (PCI) of the at least one cell of the set of cells,
a set of latitude and longitude coordinates of each location in the set of locations of the UE,
satellite information or non-terrestrial network (NTN) information decoded from a system information block (SIB) 19 (SIB19),
a radio access technology (RAT) associated with the network,
a bandwidth of the at least one cell of the set of cells, or
a combination thereof.

28. The method of claim 15, wherein the at least one location corresponds to a last location of the UE with the cellular coverage.

29. An apparatus for wireless communication at a user equipment (UE), comprising:
means for detecting that the UE is within a threshold distance of an edge cell of a set of cells for a network;
means for recording a set of locations of the UE with a cellular coverage based on detecting that the UE is within the threshold distance of the edge cell;
means for detecting that the UE is out-of-service (OOS) or soon to be OOS of the network; and
means for indicating at least one location in the set of locations of the UE in response to the UE being OOS.

30. A computer-readable medium storing computer executable code at a user equipment (UE), the code when executed by a processor causes the processor to:
detect that the UE is within a threshold distance of an edge cell of a set of cells for a network;
record a set of locations of the UE with a cellular coverage based on detecting that the UE is within the threshold distance of the edge cell;
detect that the UE is out-of-service (OOS) or soon to be OOS of the network; and
indicate at least one location in the set of locations of the UE in response to a detection that the UE is OOS.
